(19) United States
(12) Patent Application Publication
(10) Pub. No.: US 2007/0220578 A1
(43) Pub. Date: Sep. 20, 2007

(54) Cable card mounting apparatus and television receiver

(75) Inventors: Yasushi Naito, Yokohama (JP); Katsunobu Kimura, Yokohama (JP); Yuki Iwane, Chigasaki (JP); Yuichi Shibata, Fujisawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/512,696

(22) Filed: Aug. 29, 2006

(30) Foreign Application Priority Data
Mar. 17, 2006 (JP) 2006-073855

(51) Int. Cl. H04N 7/167; H04N 5/50; H04N 5/44; H04N 7/173; H04N 7/16

(52) U.S. Cl. 725/131; 725/6; 725/31; 348/725; 348/731; 725/100

(57) ABSTRACT

The present invention provides a cable card mounting apparatus capable of maintaining a temperature that conforms to operating conditions at a high environmental temperature without using a small fan or heat sink. The cable card mounting apparatus comprises a receiver housing and a card mounting section that is positioned outside the receiver housing and provided with a card slot inside the receiver housing. While a connector for a cable card is mounted in the card slot, a main body of the cable card is positioned inside the receiver housing and in parallel with a bottom surface of the receiver housing.

### CLAIM OF PRIORITY

The present application claims priority from Japanese application serial no. JP 2006-073855, filed on Mar. 17, 2006, the content of which is hereby incorporated by reference into this application.

### BACKGROUND OF THE INVENTION

(1) Field of the Invention

The present invention relates to a cable card mounting apparatus and a television receiver, and more particularly to a cable card mounting apparatus for a flat panel display and a television receiver equipped with a card mounting apparatus.

(2) Description of the Related Art

Due to the recent widespread of digitized CATV broadcasts, a technology for compressing video and audio signals by an MPEG (Motion Picture Experts Group) or other digital encoding method and transmitting a generated digital steam by a digital modulation method is adopted. Further, a pay-TV system is established. In this system, a digital stream is scrambled, that is, encrypted, at a transmitting station, and descrambled, that is, decrypted, at a receiving apparatus so that only subscribers are allowed to view broadcasts. Such a scrambling/descrambling method is called a “CA (Conditional Access)” method.

Since the CA method can be defined individually by a CATV broadcaster, the broadcasts of a broadcaster are generally receivable only by a receiver that incorporates a supported CA technology. Therefore, when the CATV broadcaster is to be changed, it is necessary to switch to a receiver that incorporates a supported CA technology.

Under the above circumstances, a technology is developed for producing a replaceable external processing module that incorporates the CA technology and eliminates the necessity for using a CA-technology-incorporated receiver. When, for instance, processing modules conforming to a cable card standard are used, the broadcasts of various CATV broadcasters can be received by switching from one processing module to another. According to this standard, the CA technology is incorporated in a processing module called a cable card. Therefore, the broadcasts of various CATV broadcasters can be received by switching to a supported cable card and without changing the receiver.

In the standard concerning the use of cable cards, the channel for transmitting a digital stream, which is to be actually viewed, from a transmitting station is called a FAT (Forward Applications Transport) channel, and the QAM (Quadrature Amplitude Modulation) method is employed as a modulation method. In addition to the FAT channel, a sub-channel called an “OOB (Out Of Band)” channel, which differs from the FAT channel in frequency, is used to transmit additional information. The OOB channel comprises a downstream channel called an FDC (Forward Data Channel), and an upstream channel called an RDC (Return Data Channel).

The FDC transmits additional information about the FAT channel, such as a channel map and encryption information, from a transmitting station. The RDC transmits receiver information and the like from a receiver to the transmitting station. However, the RDC need not always be used. The QPSK (Quadrature Phase Shift Keying) method is used as the FDC's modulation method. A QPSK reception circuit of the FDC is required independently of a QAM reception circuit that receives FAT.

FIG. 7 shows a conventional receiver that receives FAT and FDC and performs a CA descrambling process with an external processing module. The reference numeral 1 denotes the receiver. The reference numeral 2 denotes the processing module (cable card). A high-frequency modulated signal containing the FAT and FDC is input to an input terminal 10, and supplied to a FAT selection circuit 11 and FDC selection circuit 13. The FAT selection circuit 11 makes a channel selection in accordance with an FAT channel frequency. The selected modulated signal is then demodulated by an FAT demodulation circuit 12 to output a digital stream. If the FAT channel is CA-scrambled at the transmitting station, the output digital stream is scrambled. The digital stream is supplied from the receiver 1 to a decryption circuit 22 in the external processing module 2.

Similarly, the FAT selection circuit 13 makes a channel selection in accordance with an FDC channel frequency. The selected modulated signal is then demodulated by an FDC demodulation circuit 12 to output FDC data. The FDC data is supplied to a control circuit 21 in the processing module 2 and used for CA descrambling and other processing operations.

The decryption circuit 22 in the processing module 2 performs a descrambling process, that is, a decryption process on the digital stream of the FAT channel in accordance with the CA method employed by the transmitting station. The processing module 2 then outputs the processed digital stream, which is not CA-scrambled. The output digital stream is returned to the receiver 1 and supplied to a demultiplexing circuit 16. The processed digital stream contains a compressed video signal and compressed audio signal. Therefore, the processed digital stream is separated into video and audio signals by the demultiplexing circuit 16, and supplied to a video decompression circuit 17 and to an audio decompression circuit 18. The video decompression circuit 17 and audio decompression circuit 18 decompress the respective signals and output a viewable video signal and audible audio signal. If decryption is not achieved by the decryption circuit 22, the stream is still scrambled. In such a case, the video and audio signals cannot be decompressed. Even in a situation where CA scrambling is performed as described above, the FAT channel of various CATV broadcasters can be viewed by changing the processing module called the cable card and without changing the receiver.

When the above processing module (cable card) is mounted in the receiver 1, it generates heat during its operation so that its surface temperature may become considerably higher than the environmental temperature. As regards the operating temperature for normal cable card operations, the operating conditions are defined by a standard. The standard states that the temperature at a specified point of the cable card surface should not exceed 65° C. when the environmental temperature is 40° C. Under such circumstances, a small fan or heat sink has been conventionally installed to cool the cable card.

Further, a method disclosed by Japanese Patent JP-A No. 36571/1995 furnishes a main body case for an IC card with an air inlet and air outlet and cools the IC card with cool air within a housing.

### SUMMARY OF THE INVENTION

However, the use of a conventional method of installing a small fan or heat sink increases the number of parts for cooling purposes, leading to increased cost. Further, the use of a small fan results in the generation of noise due to fan rotation, thereby making it impossible to provide high-quality audio characteristics. Meanwhile, the use of a heat sink makes it difficult to provide thermal contact between the cable card and heat sink. Consequently, a large heat sink has to be used to produce an adequate heat dissipation effect. As a result, it is difficult to obtain a compact apparatus.

In the case of the disclosure described in Japanese Patent JP-A No. 36571/1995, it is necessary to cool the interior of the apparatus housing by using a separate means and direct the resulting cooled air to the air inlet and outlet for the IC card. Consequently, the use of a complicated structure is unavoidable. Further, the IC card is unstable because it is positioned outside the apparatus housing. Furthermore, an electrical connection cannot be established if a ground connection terminal is positioned outside an IC card main body.

The cable card mounting apparatus according to the present invention includes a receiver housing and a card mounting section. The card mounting section is installed outside the receiver housing and provided with a card slot, which is positioned inside the receiver housing. While a connector for a cable card is mounted in the card slot, a main body of the cable card is positioned in parallel with a bottom surface inside the receiver housing.

The present invention air-cools the periphery of the main body of the cable card positioned inside the receiver housing, and makes it possible to maintain a proper operating temperature while a high environmental temperature prevails.

### BRIEF DESCRIPTION OF THE DRAWINGS

FIG. 1 is a diagram showing a rear view of a flat panel display (FPD) and a cross-sectional view of a cable card section to which the present invention is applied.

FIG. 2 is a diagram showing a perspective view of an example of a cable card that is used with a cable card mounting apparatus according to a first embodiment.

FIG. 3 is a diagram showing a perspective view of a cable card mounting apparatus according to a first embodiment.

FIG. 4 is a diagram showing an exploded perspective view of a cable card mounting apparatus according to a first embodiment.

FIG. 5 is a diagram showing a top view, cross-sectional views, and enlarged views of a first embodiment.

FIG. 6 is a table showing the results of a temperature measurement test that was performed on a first embodiment.

FIG. 7 is a diagram showing a conventional receiver that receives FAT and FDC and performs a CA descrambling process with an external processing module.

### DETAILED DESCRIPTION OF THE EMBODIMENT

An embodiment of the present invention will now be described with reference to the accompanying drawings.

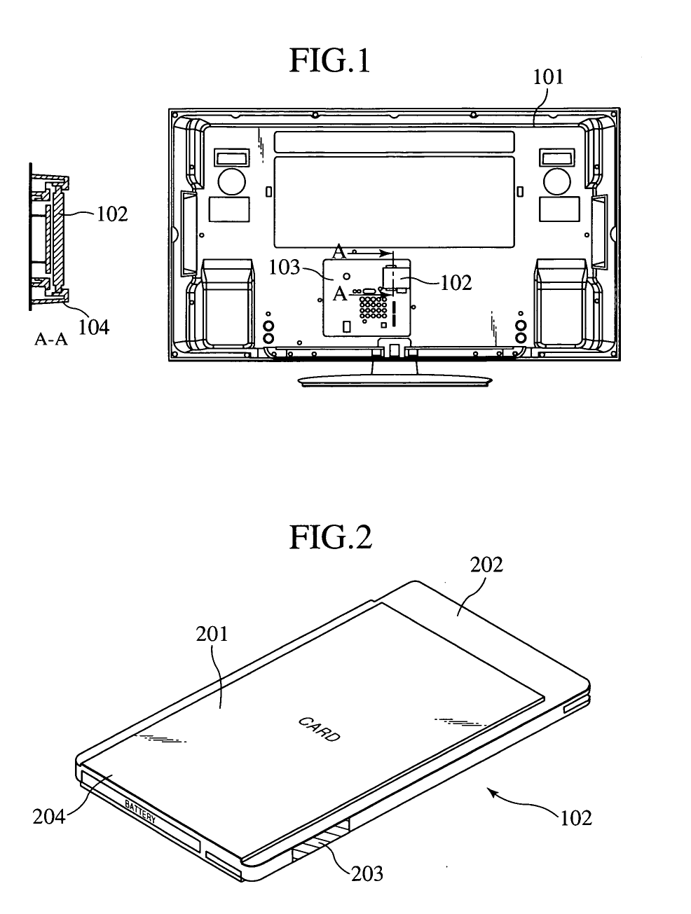

FIG. 1 shows a rear view of a flat panel display (FPD) and a cross-sectional view of a cable card section to which the present invention is applied. As indicated in FIG. 1, a receiver housing 103 is positioned on the rear 101 of the FPD. A cable card 102 is mounted on the receiver housing 103. The cable card 102 is a signal processing card that processes a television signal supplied, for instance, from a CATV. The left-hand figure in FIG. 1 is a cross-sectional view illustrating a mounting section of the cable card 102. As indicated in the cross-sectional view, the cable card 102 is retained by a retention structure 104.

FIG. 2 is a perspective view illustrating the cable card 102 that is used with a cable card mounting apparatus according to a first embodiment. As indicated in FIG. 2, the cable card 102 includes a cable card main body 201 and a connector 202. A ground terminal section 203 is provided on a lateral surface of the cable card main body 201. An end face of the cable card main body 201 is provided, for instance, with a battery compartment 204.

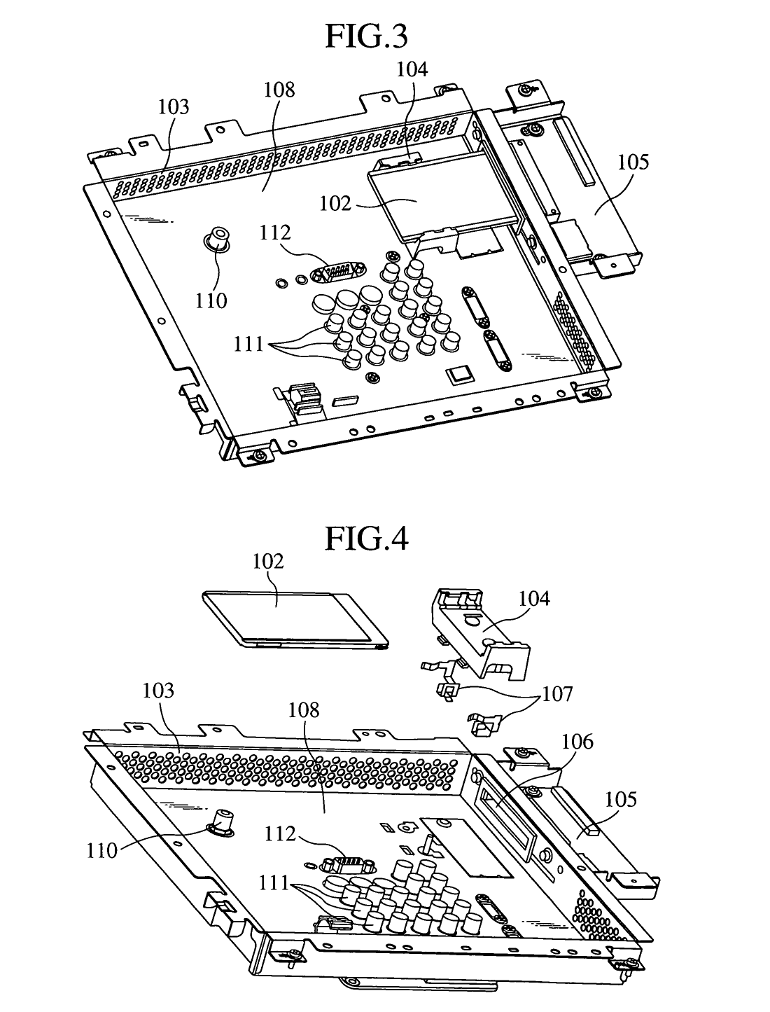

FIG. 3 is a perspective view illustrating the cable card mounting apparatus according to a first embodiment of the present invention. As indicated in FIG. 3, a box-shaped terminal board 103 is mounted on the rear of the television receiver. The terminal board 103 is coupled to the housing of the television receiver. A cable for transmitting a television signal supplied from a CATV is connected to a bottom surface of the terminal board 103. The bottom surface of the terminal board 103 is also provided with a TV input terminal 110, which receives a television signal input from the CATV, an external input terminal 111, which receives a video/audio signal input from a DVD player, VTR, or other external video apparatus, and a PC input terminal 112, which receives a signal input from a personal computer. Further, an opening for a card mounting section 105 (card slot), into which the cable card 102 is to be inserted, is provided in a lateral surface of the terminal board 103. The cable card 102 is to be inserted into this opening. While the cable card 102 is inserted in the card slot 106, it is supported by the retention structure 104. The retention structure 104 holds both sides of the cable card 102.

In the present embodiment, while the cable card 102 is mounted in the card mounting section 105, about 80 to 90% of the length of the cable card 102 is exposed to an inner space of the terminal board 103 (the space enclosed by the surfaces of the terminal board). While the cable card 102 is inserted in the card mounting section 105, the cable card 102 is positioned in parallel with the bottom surface 108 of the terminal board. A predetermined clearance (5 mm) is provided between the surface of the cable card 102 and the bottom surface 108 of the terminal board 103 so that air (outside air) is supplied to an area around the cable card main body 201. Therefore, the surface temperature of the cable card 102 can be maintained below a certain temperature during its operation. In other words, when the configuration according to the present embodiment is employed, both surfaces of at least a portion of the cable card 102 that is exposed out of the card mounting section 105 (about 80 to 90% of the length of the cable card 102) are in direct contact with outside air and air-cooled. Therefore, the temperature rise of the cable card 102 can be restrained.

The present embodiment assumes that the clearance between the surface of the cable card 102 and the bottom surface 108 of the terminal board 103 is 5 mm. However, the present invention is not limited to the provision of a clearance of 5 mm. For example, the clearance may alternatively be 20 mm or so to ensure that the cable card 102 can be installed with ease. In other words, it is preferred that the clearance in the present embodiment be approximately 5 to 20 mm. The terminal board 102 is made of metal (e.g., aluminum).

The bottom surface 108 of the terminal board 103 may be provided with a plurality of vent holes (not shown) or reticulated. In such an instance, air can be supplied to a surface that is positioned toward the bottom surface 108 of the cable card 102 even when no clearance is provided between the surface of the cable card 102 and the bottom surface 108 of the terminal board 103. Therefore, when the bottom surface 108 of the terminal board 103 is provided with a plurality of vent holes or reticulated, the surface of the cable card 102 may be brought into close contact with the bottom surface 108 of the terminal board 103.

FIG. 4 is an exploded perspective view illustrating the first embodiment of the present invention. As indicated in FIG. 4, the card mounting section 105 is positioned outside the receiver housing 103, and the card slot 106 is positioned inside the receiver housing 103. The connector 202 of the cable card 102 is inserted into the card slot 106. The lateral surfaces of the cable card 102 are supported by the retention structure 104. The retention structure 104 includes a space 109 in order to minimize the contact between the retention structure 104 and the lateral surfaces of the cable card 102. The retention structure 104 includes an electrical contact structure 107 that grounds the ground terminal section 203 of the cable card 102. The retention structure 104 may be made of metal.

When the connector 202 of the cable card 102 is inserted into the card slot 106, the cable card 102 is supported by the retention structure 104 within the receiver housing 103 and positioned in parallel with the bottom surface 108 of the receiver housing. A predetermined clearance (5 mm) is provided between the bottom 108 of the receiver housing and the cable card 102 so that air is supplied to an area around the cable card main body 201. Therefore, the surface temperature of the cable card 102 can be maintained below a certain temperature during its operation.

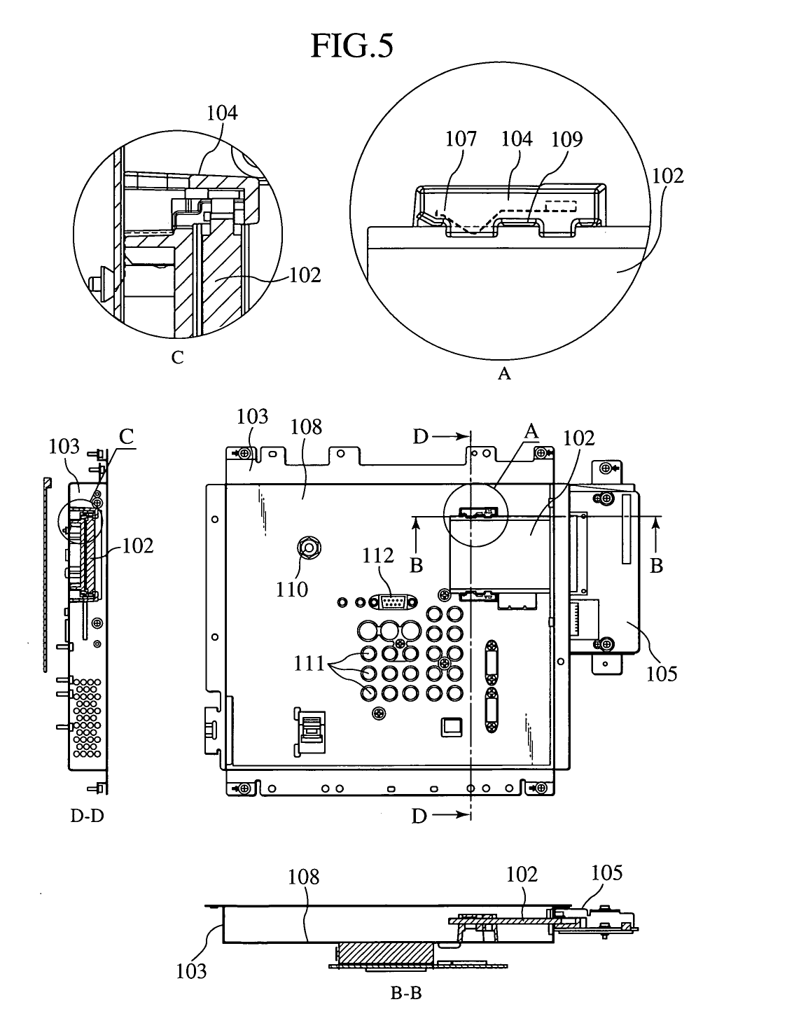

FIG. 5 presents a top view, cross-sectional views, and enlarged views of the first embodiment of the present invention. The central view in FIG. 5 is a top view illustrating the cable card mounting apparatus in which the cable card 102 is mounted within the receiver housing 103. The upper right-hand view (A) in FIG. 5 is an enlarged view illustrating the retention structure 104. The retention structure 104 includes a space 109 to minimize the contact between the retention structure 104 and the lateral surfaces of the cable card 102. The retention structure 104 also includes an electrical contact structure 107 to ground the ground terminal section 203 of the cable card 102.

The lower right-hand view (B-B) in FIG. 5 is a cross-sectional view taken along line B-B of the central view. The cable card 102 is mounted in the card mounting section 105, which is positioned outside the receiver housing 103. The main body of the cable card 102 is positioned at a predetermined distance from and in parallel with the bottom 108 of the receiver housing 103. Therefore, the upper, lower, and lateral surfaces of the cable card 102 can be air-cooled.

The left-hand view (D-D) in FIG. 5 is a cross-sectional view taken along line D-D of the central view. The cable card 102 is positioned inside the receiver housing 103. The upper left-hand view (C) is an enlarged cross-sectional view of C in the left-hand view (D-D). It shows a structure in which the cable card 102 is supported by the retention structure 104.

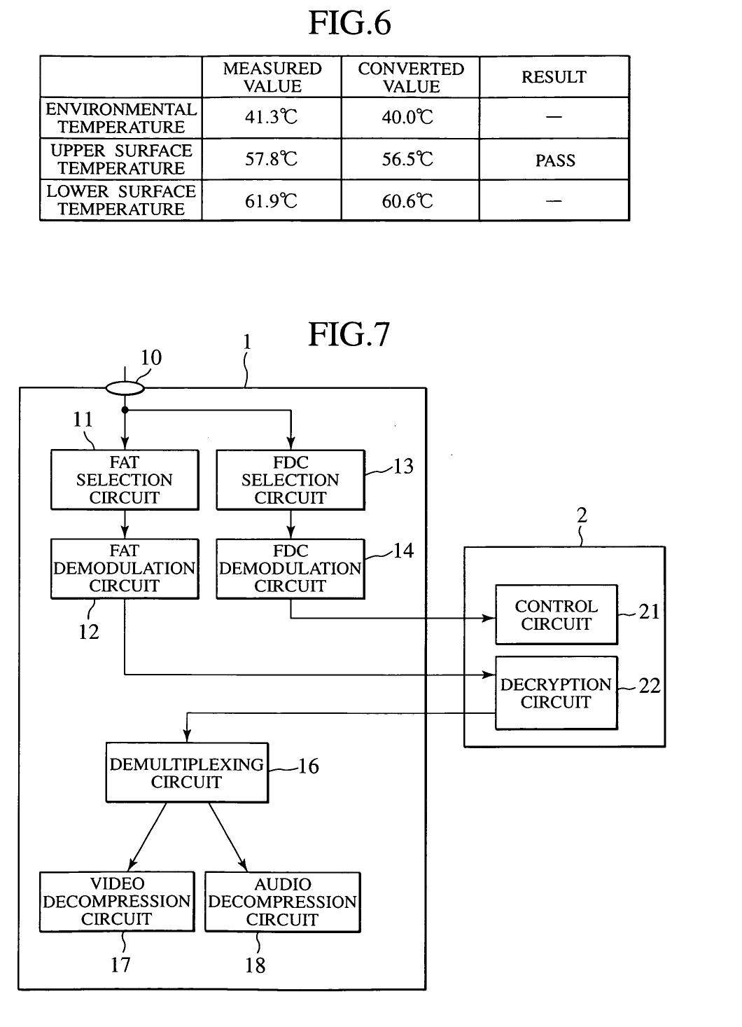

FIG. 6 shows the results of a temperature measurement test that was performed on the first embodiment of the present invention. The results of the actual measurements that were made at an environmental temperature of 41.3° C. indicate that the temperature prevailing at a specified point of the upper surface of the cable card was 57.8° C. and that the temperature of the lower surface of the cable card was 61.9° C. When the measurement results were converted to those prevailing at an environmental temperature of 40° C., which conforms to the standard, the temperature prevailing at the specified point of the upper surface of the cable card was 56.5° C.

The standard states that the temperature prevailing at the specified point of the upper surface of the cable card should be not higher than 65° C. while the environmental temperature is 40° C. It means that the cable card mounting apparatus according to the present invention conforms to the standard.

As described above, the embodiment of the present invention can provide cooling conditions conforming to the standard without using a small fan or heat sink that cools the cable card.

What is claimed is:

1. A cable card mounting apparatus comprising:
a box-shaped rear terminal board; and
a card mounting section that is positioned outside the rear terminal board and provided with a card slot inside the rear terminal board;
wherein, while a connector for a cable card is mounted in the card slot, a main body of the cable card is positioned inside the rear terminal board and in parallel with a bottom surface of the rear terminal board.

2. The cable card mounting apparatus according to claim 1, wherein the rear terminal board is positioned on a flat panel display.

3. The cable card mounting apparatus according to claim 1, wherein the cable card is inserted in parallel with the rear terminal board, and structured so that there is at least a predetermined distance between the cable card and the bottom surface of the rear terminal board.

4. The cable card mounting apparatus according to claim 3, wherein the predetermined distance is 5 to 20 mm.

5. The cable card mounting apparatus according to claim 1, wherein the bottom surface of the rear terminal board has a retention structure that retains the cable card.

6. The cable card mounting apparatus according to claim 5, wherein the retention structure includes an electrical contact structure that grounds a ground terminal section of the cable card.

7. The cable card mounting apparatus according to claim 5, wherein a card contact section of the retention structure is provided with a space in which the cable card is not in contact with the retention structure.

8. The cable card mounting apparatus according to claim 5, wherein the retention structure is made of metal.

9. The cable card mounting apparatus according to claim 1, wherein a breathable cover is installed over the cable card.

10. A television receiver comprising:
a TV input terminal for inputting a television signal; and
a card mounting section that is positioned on the rear of the television receiver and provided with a card slot;
wherein a connector for a signal processing card, which processes a television signal input from the TV input terminal, is mounted in the card slot; and
wherein, while the connector for the signal processing card is mounted in the card slot, a space is formed between the signal processing card and the rear of the television receiver.

11. The television receiver according to claim 10, wherein the rear of the television receiver has a box-shaped terminal board; wherein a bottom surface of the terminal board has the TV input terminal; wherein a lateral surface of the terminal board has the card slot; and wherein, while the connector for the signal processing card is mounted in the card slot, a main body of the signal processing card is positioned in parallel with the bottom surface of the box-shaped terminal board.

12. The television receiver according to claim 10, wherein the bottom surface of the terminal board has a plurality of vent holes.

13. The television receiver according to claim 10, wherein the bottom surface of the terminal board is reticulated.

14. A television receiver comprising:
a box-shaped terminal board that is mounted on the rear of the television receiver and provided with a TV input terminal for inputting a television signal; and
a card slot that is provided in a lateral surface of the box-shaped terminal board and accepts a connector for a signal processing card that processes a television signal input from the TV input terminal;
wherein a bottom surface of the box-shaped terminal board is provided with a plurality of vent holes or reticulated; and
wherein, while the connector for the signal processing card is mounted in the card slot, the bottom surface of the terminal board is positioned in parallel with the signal processing card.

15. The television receiver according to claim 14, wherein, while the connector for the signal processing card is mounted in the card slot, a space is formed between the signal processing card and the bottom surface of the terminal board.

16. The television receiver according to claim 14, wherein, while the connector for the signal processing card is mounted in the card slot, the bottom surface of the terminal board is in close contact with the main body of the signal processing card.
